(19) United States
(12) Patent Application Publication
(10) Pub. No.: US 2005/0178861 A1
(43) Pub. Date: Aug. 18, 2005

(54) Fuel injector having fuel filter at inlet opening

(75) Inventor: Koichi Sugiyama, Nagoya-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/047,684

(22) Filed: Feb. 2, 2005

(30) Foreign Application Priority Data
Feb. 13, 2004 (JP) 2004-36399

(51) Int. Cl. B05B 1/30; F02M 51/00

(52) U.S. Cl. 239/585.1

(57) ABSTRACT

A fuel injector includes a cylindrical member forming an elongate fuel passage therein. A fuel filter is disposed at an inlet opening of the cylindrical member to remove foreign particles contained in fuel to be supplied to an internal combustion engine. The fuel filter is composed of a frame made of resin and a substantially flat filter element supported in the frame. The frame includes a cylindrical portion forcibly inserted into the inner bore of the cylindrical member of the fuel injector. Since the filter element is substantially flat, the filter element is easily supported in the frame, and the fuel filter can be manufactured at a low cost.

### CROSS-REFERENCE TO RELATED APPLICATION

This application is based upon and claims benefit of priority of Japanese Patent Application No. 2004-36399 filed on Feb. 13, 2004, the content of which is incorporated herein by reference.

### BACKGROUND OF THE INVENTION

1. Field of the Invention

The present invention relates to a fuel injector for supplying fuel into an internal combustion engine, the fuel injector including a fuel filter disposed at a fuel inlet opening.

2. Description of Related Art

An example of the fuel injector having a fuel filter at its inlet opening is disclosed in JP-A-9-324717. A relevant portion of such a fuel injector and a fuel filter installed in the fuel injector are shown in FIGS. 23 and 24A-24C attached hereto. As shown in FIG. 23, a fuel injector 400 includes a cylindrical member 402 forming an elongate fuel passage 420 therein and a fuel filter 410 disposed at an inlet opening of the cylindrical member 402. As shown in FIG. 24A-24C, the fuel filter 410 is composed of a cylindrical frame 412, a collar 416 surrounding an upper portion of the frame 412 and a filter sheet 414 disposed around the frame 412.

The collar 410 is made of a thin metal sheet and the frame is made of resin. The filter sheet 414 is a mesh sheet disposed around the resin frame 412. The fuel filter 410 is press-fitted into the inlet opening of the cylindrical member 402, as shown in FIG. 23. A process for disposing the fuel sheet 414 around the cylindrical frame 412 requires a certain time, making the manufacturing cost high.

### SUMMARY OF THE INVENTION

The present invention has been made in view of the above-mentioned problem, and an object of the present invention is to provide an improved fuel injector having a fuel filter which has a high filtering ability and is manufactured at a low cost.

The fuel injector for injecting fuel into an internal combustion engine includes a cylindrical member forming an elongate fuel passage therein. Fuel is introduced into the fuel passage from an inlet opening of the cylindrical member and injected into the engine through a valve disposed in the downstream end of the cylindrical member. The valve is electromagnetically controlled to its open or closed position. A fuel filter for removing foreign particles contained in the fuel is disposed at the inlet opening, and a portion connecting the inlet opening to a pipe feeding the fuel is sealed by an O-ring.

The fuel filter is composed of a frame made of resin and a filter element supported in the frame. The filter element is a substantially flat mesh made of stainless steel or nylon. The frame includes a cylindrical portion and a circular portion for supporting the fringe of the filter element. Since the filter element is substantially flat, it is easily supported in the frame, and therefore the fuel filter is manufactured at a low cost. The fuel filter is connected to the inner bore of the cylindrical member by forcibly inserting the cylindrical portion.

The flat filter element may be additionally supported by a reinforcing beam integrally formed with the cylindrical portion of the frame. The reinforcing beam may be one beam formed along the diameter of the filter element or three or four beams extending in the radial direction from the center of the filter element. A center portion of the filter element may be depressed in the fuel flow direction so that the removed foreign particles are retained in the depressed portion. The filter element may be inclined with respect to the fuel flow so that the foreign particles are retained at an lower portion of the filter element. The cylindrical portion of the frame may be covered with a thin metallic collar.

Projections may be formed on the outer periphery of the cylindrical portion of the frame so that the projections engage with a depression formed in the inner bore of the cylindrical member of the fuel injector. It is preferable to position the engaging portion downstream of the O-ring disposed at the inlet opening of the cylindrical member to make the axial length of the fuel filter short. The outer periphery of the cylindrical member is covered with a resin material forming a housing of the fuel injector.

Other objects and features of the present invention will become more readily apparent from a better understanding of the preferred embodiments described below with reference to the following drawings.

### BRIEF DESCRIPTION OF THE DRAWINGS

FIG. 1A is a plan view showing a fuel filter as a first embodiment of the present invention;

FIG. 1B is a cross-sectional view showing the fuel filter, taken along line IB-IB shown in FIG. 1;

FIG. 2 is a cross-sectional view showing a fuel injector to which the fuel filter of the present invention is installed;

FIG. 3A is a plan view showing a fuel filter as a variation 1 of the first embodiment;

FIG. 3B is a cross-sectional view showing the fuel filter, taken along line IIIB-IIIB shown in FIG. 3A;

FIG. 4A is a plan view showing a fuel filter as a variation 2 of the first embodiment;

FIG. 4B is a cross-sectional view showing the fuel filter, taken along line IVB-IVB shown in FIG. 4A;

FIG. 5A is a plan view showing a fuel filter as a second embodiment of the present invention;

FIG. 5B is a cross-sectional view showing the fuel filter, taken along line VB-VB shown in FIG. 5A;

FIG. 6A is a plan view showing a fuel filter as a variation 1 of the second embodiment;

FIG. 6B is a cross-sectional view showing the fuel filter, taken along line VIB-VIB shown in FIG. 6A;

FIG. 7A is a plan view showing a fuel filter as a variation 2 of the second embodiment;

FIG. 7B is a cross-sectional view showing the fuel filter, taken along line VIIB-VIIB shown in FIG. 7A;

FIG. 8 is a cross-sectional view showing a fuel filter as a third embodiment of the present invention;

FIG. 9A is a plan view showing a fuel filter as a fourth embodiment of the present invention;

FIG. 9B is a cross-sectional view showing the fuel filter, taken along line IXB-IXB shown in FIG. 9A;

FIG. 10A is a plan view showing a fuel filter as a fifth embodiment of the present invention;

FIG. 10B is a cross-sectional view showing the fuel filter, taken along line XB-XB shown in FIG. 10A;

FIG. 11 is a cross-sectional view showing a fuel filter as a sixth embodiment of the present invention;

FIG. 12 is a cross-sectional view showing a fuel filter as a seventh embodiment of the present invention;

FIG. 13 is a cross-sectional view showing a fuel filter as an eighth embodiment of the present invention;

FIG. 14 is a cross-sectional view showing a fuel injector to which the fuel filter as the eighth embodiment of the present invention is installed;

FIG. 15 is a cross-sectional view showing a fuel filter as a ninth embodiment of the present invention;

FIG. 16 is a cross-sectional view showing a fuel filter as a tenth embodiment of the present invention;

FIG. 17 is a cross-sectional view showing a fuel filter as an eleventh embodiment of the present invention;

FIG. 18 is a cross-sectional view partly showing a fuel injector to which the fuel filter as the eleventh embodiment of the present invention is installed;

FIG. 19 is a cross-sectional view showing a fuel filter as a twelfth embodiment of the present invention;

FIG. 20 is a cross-sectional view showing a fuel filter as a thirteenth embodiment of the present invention;

FIG. 21 is a cross-sectional view showing a fuel filter as a fourteenth embodiment of the present invention;

FIG. 22 is a cross-sectional view partially showing a fuel injector to which the fourteenth embodiment of the present invention is installed;

FIG. 23 is a cross-sectional view showing a conventional fuel injector;

FIG. 24A is a plan view showing a conventional fuel filter installed to the conventional fuel injector shown in FIG. 23;

FIG. 24B is a cross-sectional view showing the fuel filter, taken along line XXIVB-XXIVB shown in FIG. 24A; and

FIG. 24C is a side view showing the fuel filter, viewed in direction XXIVC shown in FIG. 24A.

### DETAILED DESCRIPTION OF THE PREFERRED EMBODIMENTS

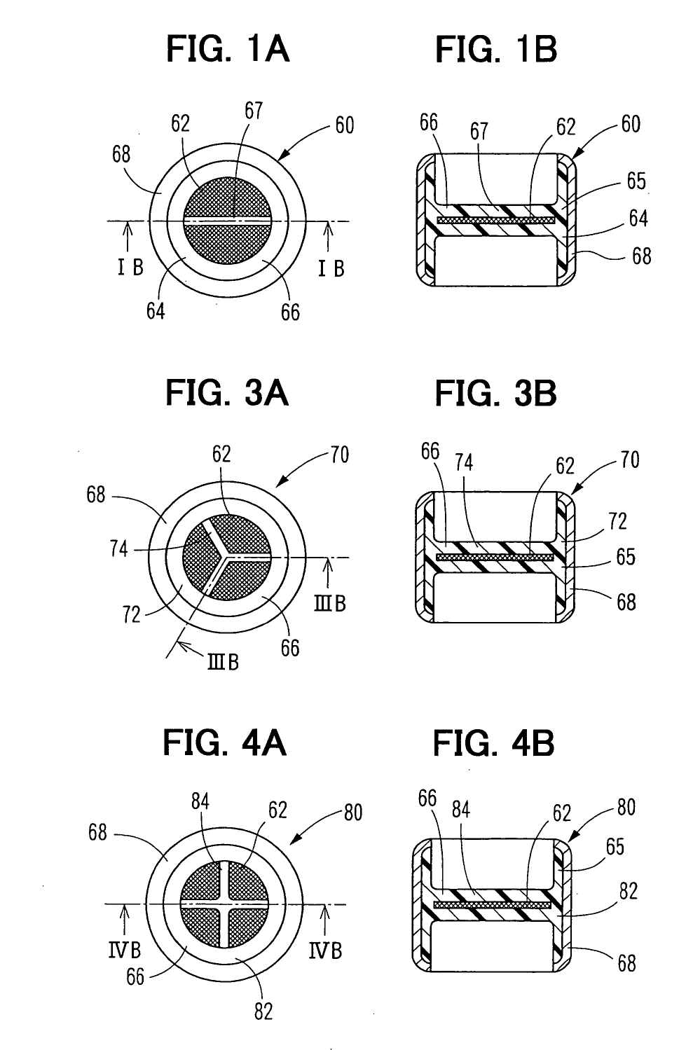

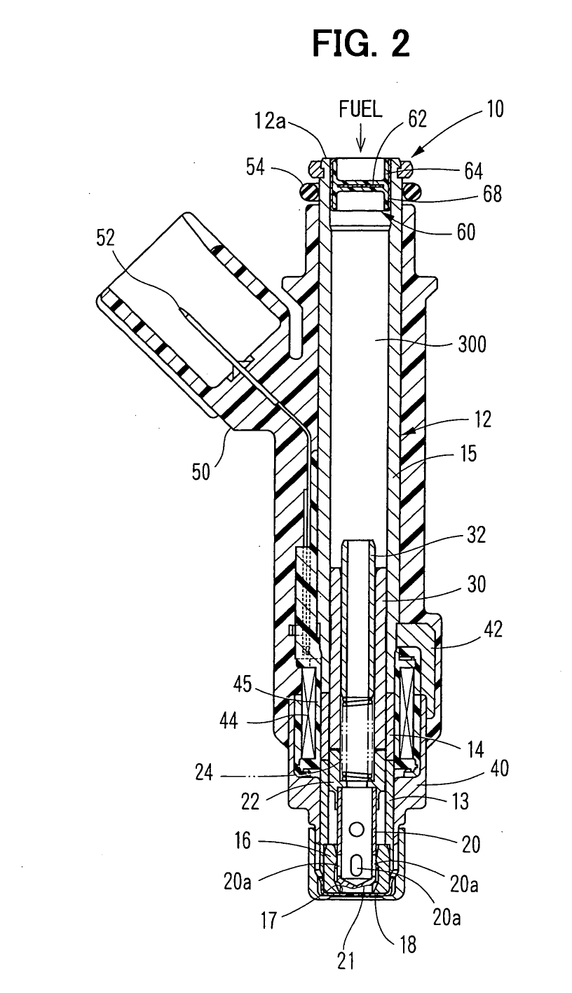

A first embodiment of the present invention will be described with reference to FIGS. 1A, 1B and 2. First, referring to FIG. 2, a fuel injector 10 to which a fuel filter 60 of the present invention is installed will be described. The fuel injector 10 includes a cylindrical member 12 in which an elongate fuel passage 300 is formed. A fuel filter 60 is disposed at an inlet opening 12a of the cylindrical member 12. A valve body 16, a valve member 20, a movable core 22, a spring 24, a stationary core 30 and an adjusting pipe 32 are contained in the cylindrical member 12.

The cylindrical member 12 is composed of, from the bottom portion of FIG. 2, a first magnetic portion 13, a non-magnetic portion 14 and a second magnetic portion 15, all connected to one another by welding such as laser welding. The non-magnetic portion 14 disposed between the first magnetic portion 13 and the second magnetic portion 15 interrupts a magnetic path between two magnetic portions 13, 15. A valve body 16 having a valve seat 17 is connected to the bottom portion of the cylindrical member 12 by welding. An injection plate 18 made of a thin metal plate and formed into a cup shape is connected to an outer periphery of the valve body 16 by welding. Injection holes are formed at an center portion of the injection plate 18.

The valve member 20 is formed in a cylinder shape having a bottom wall where an abutting portion 21 abutting the valve seat 17 is formed. When abutting portion 21 of the valve member 20 seats on the valve seat 17 of the valve body 16, the injection holes formed in the injection plate 18 are closed to terminate fuel injection. Holes 20a through which fuel flows out from the valve member 20 are formed in the cylindrical wall of the valve member 20. A movable core 22 is connected to an upper end of the valve body 20.

The stationary core 30 is press-fitted into the cylindrical member 12 and connected thereto so that bottom end of the stationary core 30 is positioned at the position where the non-magnetic portion 14 is located. The bottom end of the stationary core 30 faces the upper end of the movable core 22, forming a certain gap therebetween. The stationary core 30 is made of a magnetic material, and a non-magnetic material is coated on the bottom end of the stationary core 30. The adjusting pipe 32 is connected to the inner bore of the stationary core 30, so that a certain space to accommodate a spring 24 is formed inside the stationary core 30. The spring 24 applies a basing force to the movable core 22 in a direction to push downward the valve member 20. An amount of the biasing force is adjusted by adjusting the position of the adjusting pipe in the stationary core 30.

A coil 44 wound around a cylindrical spool 45 is disposed outside the cylindrical member 12. A first outer core 40 and a second outer core 42, both made of a magnetic material and connected to each other, are disposed outside the coil 44. The first outer core 40 is magnetically connected to the first magnetic portion 13 and the second outer core 42 is magnetically connected to the second magnetic portion 15. Thus, a magnetic circuit (or a magnetic path) is formed by the stationary core 30, the movable core 22, the first magnetic portion 13, the first outer core 40, the second outer core 42, and the second magnetic portion 15.

A housing 50 is formed by molding a resin material to cover the outer periphery of the cylindrical member 12 and the coil 44. A terminal 52 electrically connected to the coil 44 to supply electric current thereto is exposed to an open space in the housing 50, as shown in FIG. 2. An O-ring 54 is disposed outside the cylindrical member 12 at a position close to the inlet opening 12a to seal a portion connecting a fuel supply pipe (not shown) and the inlet opening 12a of the fuel injector 10.

The fuel filter 60 is press-fitted into an inner bore of the cylindrical member 12 at a position close to the inlet opening 12a. The fuel filter 60 is shown in FIGS. 1A and 1B in detail. The fuel filter 60 is composed of a frame 64 made of resin, a filter element 62 supported by the frame 64 and a collar 68 made of a metal plate. The frame 64 includes a cylindrical portion 65, circular portion 66 formed inside the cylindrical portion 65 to support the outer fringe of the filter element 62, and a reinforcing beam 67. The filter element 62 is a substantially flat mesh made of a resin material, such as nylon, or stainless steel. The filter element 62 is integrally molded with the frame 64. The outer fringe of the filter element 62 is held by the circular portion 66 of the frame 64, and a diameter portion of the filter element 62 is further supported by the reinforcing beam 67, as shown in FIG. 1A. The collar 68 covers the outside of the cylindrical portion 65 of the frame 64.

The fuel injector 10 described above operates in the following manner. When the coil 44 is de-energized, the valve constituted by the valve body 16 and the valve member 20 is closed by the biasing force of the spring 24, thereby shutting off the fuel supply to the engine. When the coil 44 is energized, the valve constituted by the valve body 16 and the valve member 20 is opened because the movable core 22 moves upward against the biasing force of the spring 24. The fuel introduced into the fuel passage 300 from the inlet opening 12a is filtered by the fuel filter 60 to remove foreign particles contained in the fuel. The filtered fuel is injected from the injection holes of the injection plate 18 through the fuel passage 300, a passage in the movable core 22, holes 20a of the valve member 20, and the valve gap between the valve seat 17 and the abutting portion 21.

In the first embodiment described above, the filter element 62 is formed in a flat shape and supported by the frame 64 by molding together. Therefore, the process of manufacturing the fuel filter 60 is considerably simplified, compared with that of the conventional fuel filter.

The first embodiment described above may be modified to the form shown in FIGS. 3A and 3B as a variation 1 of the first embodiment, or the form shown in FIGS. 4A and 4B as a variation 2 of the first embodiment. In the variation 1, a frame 72 forming a fuel filter 70 is modified from the frame 64 of the first embodiment. Three reinforcing beams 74 are formed to extend in the radial direction at equal angular intervals among one another. Other structures are the same as those of the first embodiment.

In the variation 2, a frame 82 forming a fuel filter 80 is modified from the frame 64 of the first embodiment. Four reinforcing beams 84 are formed to extend in the radial direction at an equal angular interval of a right angle. In both of the variations 1 and 2, the filter element 62 is further firmly supported by the plural reinforcing beams 74 or 84.

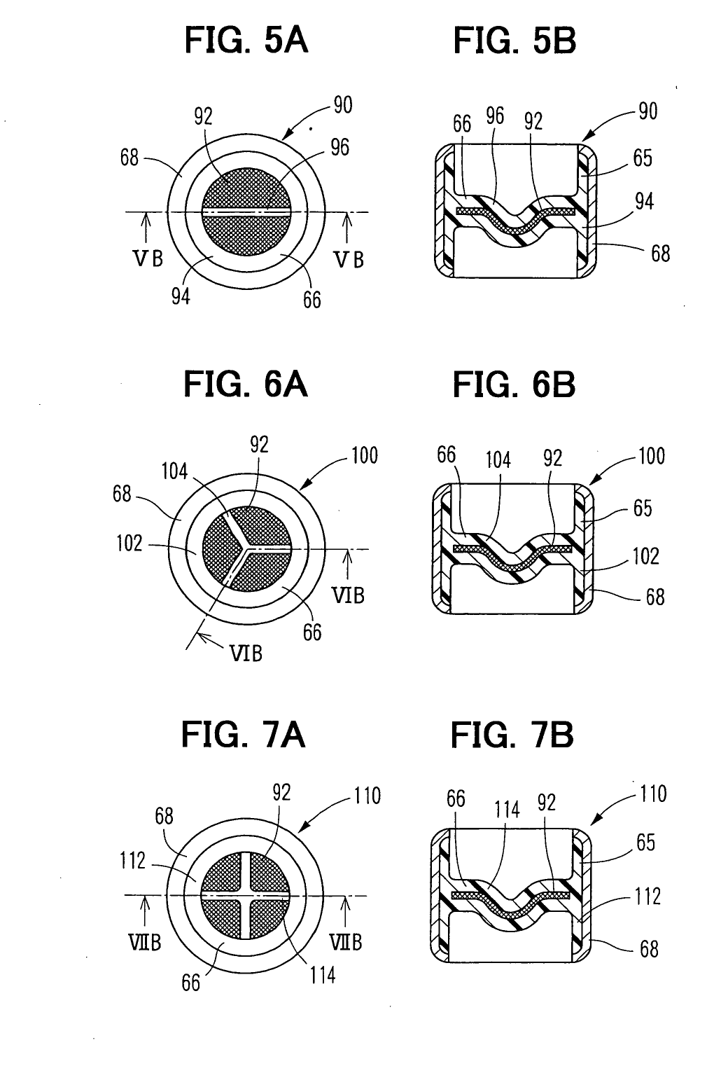

A second embodiment of the present invention is shown in FIGS. 5A and 5B. In this embodiment, a frame 94 and a filter element 92 forming a fuel filter 90 are modified from those of the first embodiment. Other structures are the same as those of the first embodiment. The center portion of the filter element 92 is depressed in the direction of the fuel flow, and the depressed portion is supported by the reinforcing beam 96 having the same form as the filter element 92. Foreign particles contained in the fuel are retained in the depressed portion of the filter element 92, thereby avoiding an entire filtering surface from being covered with the captured foreign particles. Further, an area of the filtering surface is increased by making the depressed portion in the filter element 92.

The second embodiment may be modified to the form shown in FIGS. 6A and 6B as a variation 1 of the second embodiment or to the form shown in FIGS. 7A and 7B as a variation 2 of the second embodiment. In the variation 1, a frame 102 forming a fuel filter 100 is modified to have three reinforcing beams 104 extending in the radial direction. In variation 2, a frame 112 forming a fuel filter 110 is modified to have four reinforcing beams 114 extending in the radial direction. Angular intervals in these beams 104, 114 are similar to those of the variations 1 and 2 of the first embodiment.

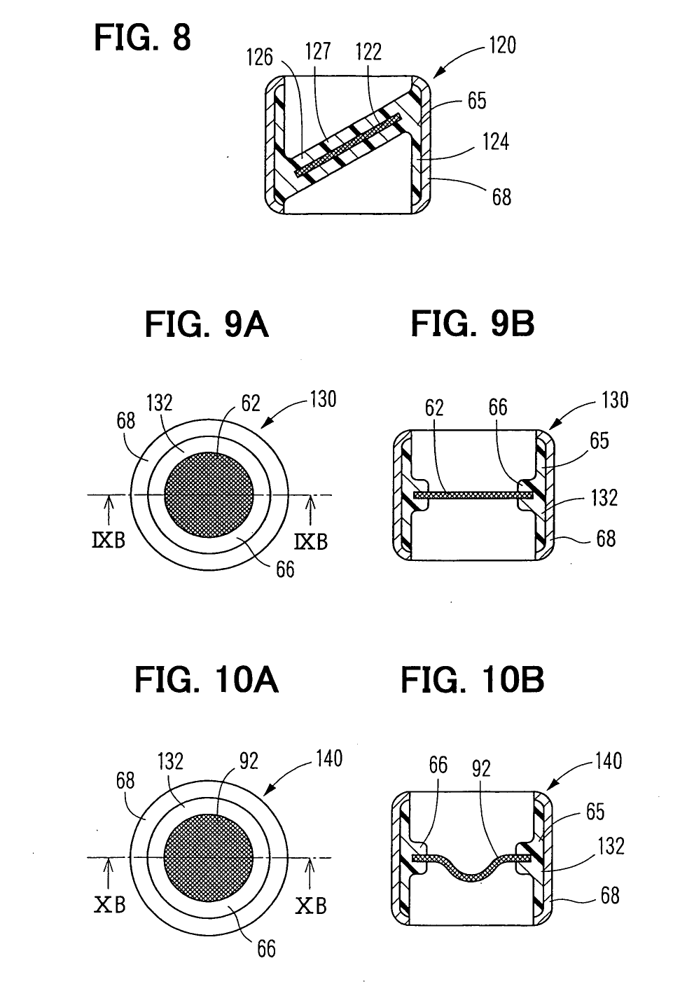

A third embodiment of the present invention is shown in FIG. 8. In this embodiment, a filter element 122 of a fuel filter 120 is supported in a frame 124 so that the filtering surface is inclined relative to the direction of the fuel flow. In the first embodiment, the filtering surface is placed perpendicularly to the fuel flow direction. The inclined filter element 122 is supported by a circular portion 126 at its fringe and by reinforcing beam 127 in its diameter portion. Other structures are the same as those of the first embodiment.

In the third embodiment, the captured foreign particles are retained in a downward portion of the inclined filtering surface. Thus, it is avoided that an entire filtering surface is covered with the captured foreign particles, and at least a certain portion of the filtering surface remains always available for filtering the fuel. In addition, the filtering area is increased by inclining the filter element 122, compared with the filtering area in the first embodiment.

A fourth and a fifth embodiment of the present invention are shown in FIGS. 9A, 9B and 10A, 10B, respectively. In the fourth embodiment, a frame 132 of a fuel filter 130 is modified from the frame 64 of the first embodiment. The reinforcing beam 67 provided in the first embodiment is eliminated. The filter element 62 is solely supported by the circular portion 66 at its fringe portion. In a fuel filter 140 as the fifth embodiment, a filter element 92 having a center portion depressed in the fuel flow direction is used in place of the flat filter element 62 used in the fourth embodiment.

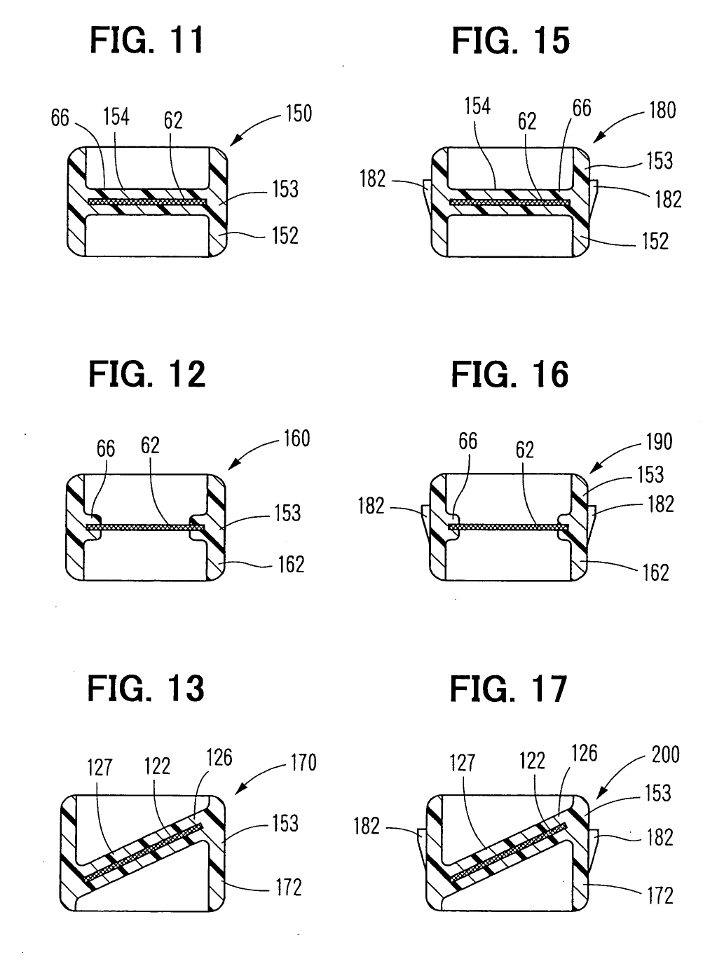

A fuel filter 150 as a sixth embodiment of the present invention, a fuel filter 160 as a seventh embodiment, and a fuel filter 170 as a eighth embodiment are shown in FIGS. 11, 12 and 13, respectively. In these embodiments, the metallic collar 68 used in the first embodiment is eliminated. In the sixth embodiment, a frame 152 is composed of a cylindrical portion 153 and a flat reinforcing beam 154. In the seventh embodiment, a frame 162 has no reinforcing beam, and the filter element 62 is solely supported by the circular portion 66. In the eighth embodiment, a frame 172 has an inclined reinforcing beam 127, and the filter element 122 is supported by a circular portion 126 and the inclined reinforcing beam 127.

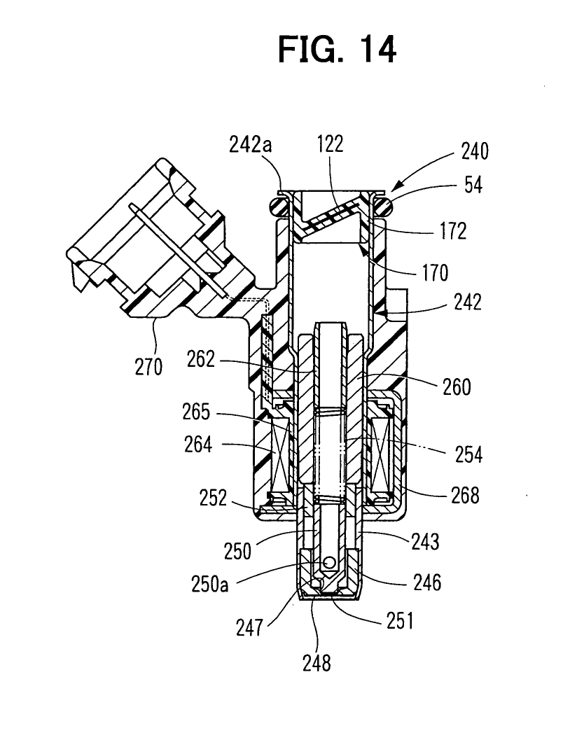

FIG. 14 shows a fuel injector 240 to which the fuel filter 170 shown in FIG. 13 as the eighth embodiment of the present invention is installed. The fuel filter 170 may be replaced with the other fuel filter 150 or 160. The fuel filter 170 is directly press-fitted in an inlet opening 242a of the fuel injector 240. A cylindrical member 242 is made of a non-magnetic material, and a magnetic sleeve 243 made of a magnetic material is inserted into an inner bore of the cylindrical member 242 from its bottom end and connected thereto by welding.

A valve body 246 having a valve seat 247 is connected to the bottom end of the magnetic sleeve 243. An injection plate 248 made of a thin metal plate having plural injections holes is connected to an bottom wall of the valve body 246. A valve member 250, formed in a cylinder shape having a closed bottom end, is connected to a movable core 252 made of a magnetic material. The movable core 252 is slidably disposed in an inner bore of the magnetic sleeve 243. A stationary core 260 made of a magnetic material is press-fitted in the cylindrical member 242, and an adjusting pipe 262 is press-fitted in the stationary core 260. A spring 254 is disposed between the adjusting pipe 262 and the valve member 250 so that the valve member 250 is biased toward the injection plate 248. The valve member 250 has holes 250a through which fuel flows out toward the injection plate 248. The valve member 250 also includes an abutting portion 251 that abuts an valve seat 247 formed on the valve body 246.

A coil 264 wound around a cylindrical spool 265 is disposed outside the cylindrical member 242, and an outer core 268 made of a magnetic material is positioned outside the coil 264. A magnetic circuit is formed by the movable core 252, the magnetic sleeve 243, the outer core 268 and the stationary core 260. A housing 270 is formed by molding a resin material to cover the outside of the cylindrical member 242, the coil 246 and the outer core 268. An O-ring 54 is disposed around the outer periphery of the inlet opening 242a for sealing.

When the coil 264 is energized, the movable core 252 is attracted to the stationary core 260, and the valve constituted by the valve seat 247 and the abutting portion 251 is opened. Fuel introduced into the fuel injector 240 from the inlet opening 242a is filtered by the fuel filter 170 and supplied to the engine through the opened valve and the injection holes formed in the injection plate 248. When the coil 264 is de-energized, the valve is closed by the biasing force of the spring 254 to terminate fuel supply to the engine.

A fuel filter 180 as a ninth embodiment, a fuel filter 190 as a tenth embodiment, and a fuel filter 200 as an eleventh embodiment of the present invention are shown in FIGS. 15, 16 and 17, respectively. These embodiments are similar to the sixth, seventh and eighth embodiments, respectively, except that projections 182 are formed on the outer periphery of the frame 152, 162, 172. The projections 182 are formed around the cylindrical portion 153 at equal intervals among one another.

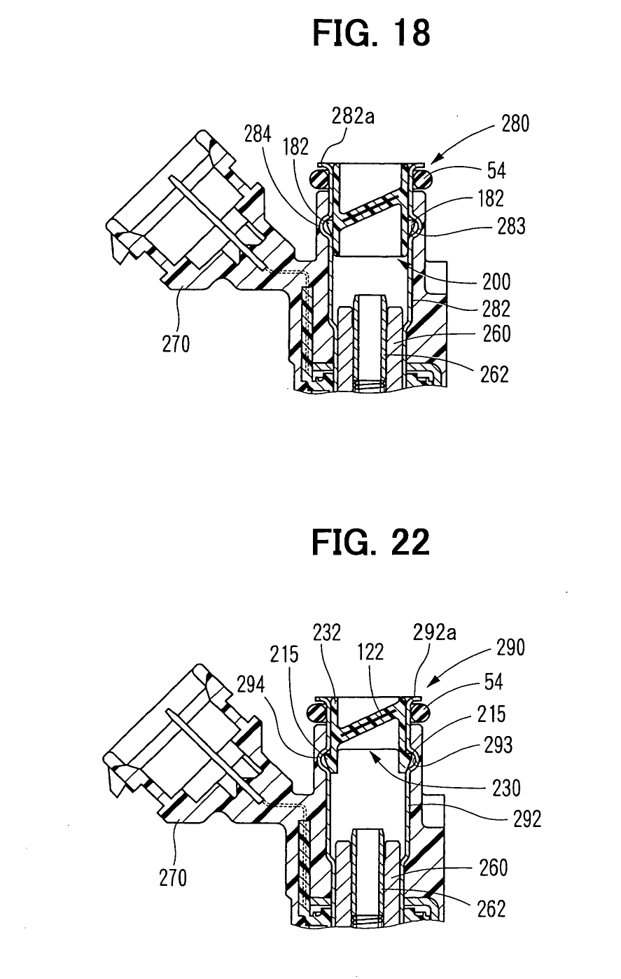

FIG. 18 shows a relevant portion of a fuel injector 280 to which the fuel filter 200 as the eleventh embodiment is installed. In place of the fuel filter 200, the fuel filter 180 or the fuel filter 190 can be similarly installed to the fuel injector 280. In FIG. 18, the same components as those shown in FIG. 14 are numbered with the same reference numbers. A cylindrical member 282 (that is similar to the cylindrical member 242 shown in FIG. 14) has a circular groove which makes an inside depression 283 and an outer projection 284. The projections 182 of the fuel filter 200 engage with the circular groove of the cylindrical member 282. The housing 270 made of molded resin covers the outside of the cylindrical member 282 including the outer projection 284. A contacting length between the molded resin (housing 270) and the outside of the cylindrical member 282 becomes longer due to the outer projection 284, and therefore water is effectively prevented from entering into a gap between the molded resin and the cylindrical portion 282.

The fuel filter 200 inserted from the inlet opening 282a is press-fitted inside the cylindrical member 282, and the projections 182 of the fuel filter 200 engages with the circular groove of the cylindrical member 282. Therefore, the fuel filter 200 is firmly held in the cylindrical member 282. Since the projections 182 are positioned below the O-ring 54, the projections 182 can be formed without much increasing the length of the frame 172.

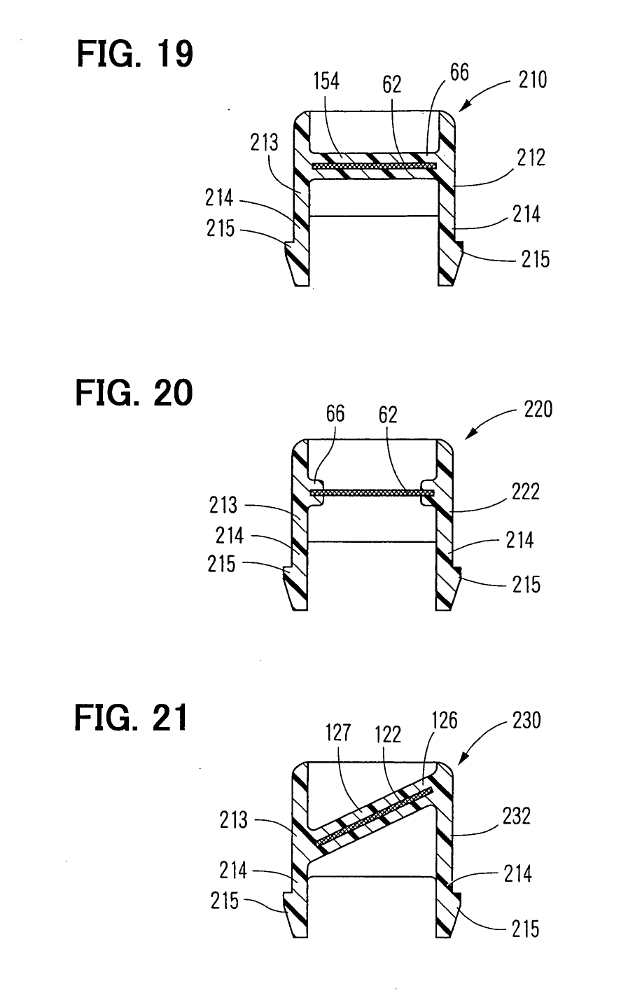

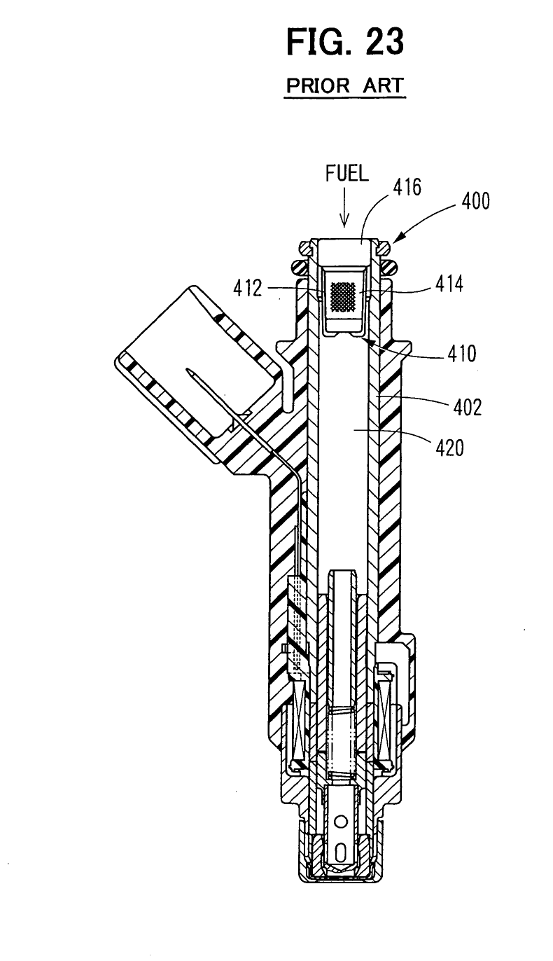

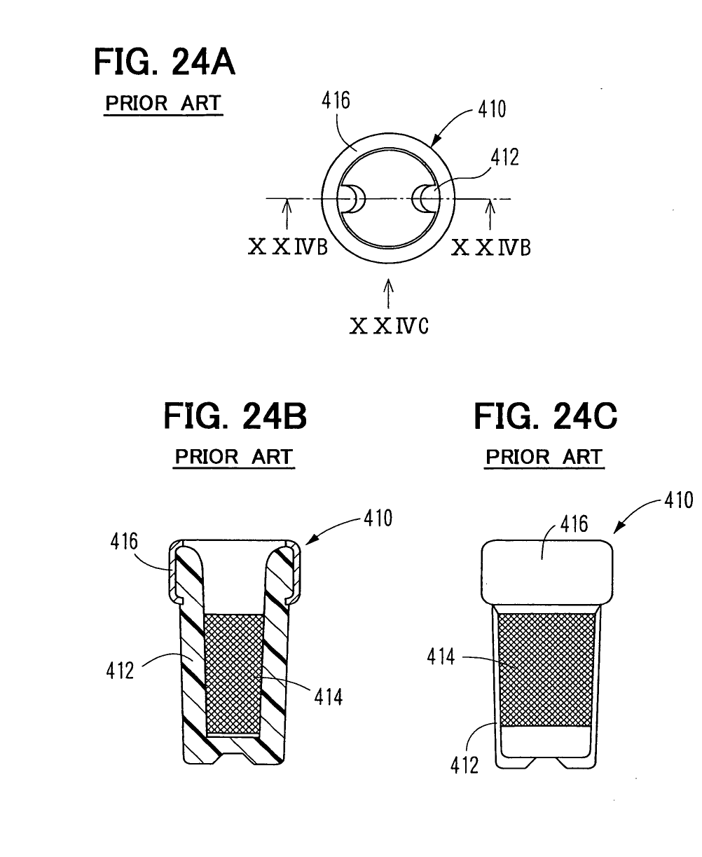

A fuel filter 210 as a twelfth embodiment, a fuel filter 220 as a thirteenth embodiment, and a fuel filter 230 as a fourteenth embodiment of the present invention are shown in FIGS. 19, 20 and 21, respectively. In these embodiments, legs 214 having a projection 215 are added to the fuel filters.

The fuel filter 210 shown in FIG. 19 is composed of a frame 212 made of resin and a filter element 62. The frame 212 includes a cylindrical portion 213, a circular portion 66, a reinforcing beam 154 and plural legs 214 extending from the cylindrical portion 213. The legs 214 are formed at an equal intervals among one another, and each leg 214 has a projection 215 projected outwardly. The filter 220 shown in FIG. 20 is composed of a frame 222 and a filter element 62. The frame 222 is similar to the frame 212 except that the frame 222 does not include the reinforcing beam 154, and the filter element 62 is solely supported by the circular portion 66. The fuel filter 230 shown in FIG. 21 is composed of a frame 232 and a filter element 122. The filter element 122 is supported by a circular portion 126 and a reinforcing beam 127 at an inclined position in the frame 232. The frame 232 includes the same legs 214 as the frame 212.

A fuel injector 290 to which the fuel filter 230 as the fourteenth embodiment is installed is shown in FIG. 22. In place of the fuel filter 230, the fuel filter 210 or the fuel filter 220 may be installed to the fuel injector 290. A circular groove forming an inside depression 293 and an outer projection 294 is formed in the cylindrical member 292. The fuel filter 230 is forcibly inserted into the cylindrical member 292 from the inlet opening 292a, and the projections 215 of the fuel filter 230 are engaged with the circular groove of the cylindrical member 292.

The outer periphery of the cylindrical member 292 including the outer projections 294 is covered with molded resin forming the housing 270. Water penetration through the gap between the housing 270 and the cylindrical member 292 is prevented by the outer projection 294 in the same manner as in the fuel injector 280 shown in FIG. 18. Since the circular groove forming the inside depression 293 and the outer projection 294 is located below the O-ring 54, the projections 215 can be formed without much increasing the length of the frame 232.

In all of the embodiments described above, the filter element in a substantially flat shape is used. Therefore, the filter element can be easily supported by the frame, and the fuel filter can be manufactured at a low cost.

The present invention is not limited to the embodiments described above, but it may be variously modified. For example, the frame supporting the filter element may be made of a metallic material instead of a resin material. Though the cylindrical portion, the circular portion and the reinforcing portion of the frame are all integrally formed by molding, it is also possible to make these components separately and assemble them afterwards. Though the projections are formed on the frame, and the circular groove is formed in the cylindrical member, e.g., in the eleventh embodiment and the fourteenth embodiment, the projections and the groove may be reversed. That is, projections formed in the cylindrical member may be engaged with a groove or a depression formed on the frame. Though the O-ring is used for sealing the inlet opening portion, other members than the O-ring may be used.

While the present invention has been shown and described with reference to the foregoing preferred embodiments, it will be apparent to those skilled in the art that changes in form and detail may be made therein without departing from the scope of the invention as defined in the appended claims.

1. A fuel injector for supplying fuel to an internal combustion engine, the fuel injector comprising:
a cylindrical member having an inlet opening from which fuel is introduced into the fuel injector; and
a fuel filter for preventing foreign particles contained in fuel from entering into the fuel injector, the fuel filter being positioned in the vicinity of the inlet opening of the cylindrical member, the fuel filter comprising a substantially flat filter element and a frame for supporting the filter element and for fixing the fuel filter to an inner bore of the cylindrical member.

2. The fuel injector as in claim 1, wherein:
a center portion of the filter element is depressed toward a downstream direction of a fuel flow in the cylindrical member.

3. The fuel injector as in claim 1, wherein:
the filter element is inclined with respect to a direction of a fuel flow in the cylindrical member.

4. The fuel injector as in claim 1 wherein:
the fuel injector further includes a sealing member disposed outside of the cylindrical member at a position close to the inlet opening of the cylindrical member;
the frame includes a cylindrical portion inserted into an inner bore of the cylindrical member and means for engaging with the inner bore of the cylindrical member; and
the engaging means is positioned downstream of the sealing member with respect to a fuel flow in the cylindrical member.

5. The fuel injector as in claim 4, wherein:
the cylindrical member is made of a thin plate having a circular depression or projection formed on a cylindrical wall thereof;
the engaging means of the frame engages with the circular depression or projection of the cylindrical member; and
an outer periphery of the cylindrical member is covered with a resin material forming a housing so that the resin material firmly engages with the projection or depression of the cylindrical member.

6. The fuel injector as in claim 1, wherein:
the frame of the fuel filter includes a cylindrical portion and a cylindrical metallic collar covering the outer periphery of the cylindrical portion; and
the frame is connected to an inner bore of the cylindrical member by forcibly inserting the frame thereinto.
